(19) United States
(12) Patent Application Publication
(10) Pub. No.: US 2003/0020816 A1
(43) Pub. Date: Jan. 30, 2003

(54) Image capturing device

(76) Inventors: Andrew Arthur Hunter, Bristol (GB); David Athur Grosvenor, Bristol (GB)

Correspondence Address: HEWLETT-PACKARD COMPANY, Intellectual Property Administration, P.O. Box 272400, Fort Collins, CO, 80527-2400, US

(21) Appl. No.: 10/200,243

(22) Filed: Jul. 23, 2002

(30) Foreign Application Priority Data
Jul. 27, 2001 (GB) 0118441.5

(51) Int. Cl. H04N 5/262

(52) U.S. Cl. 348/231.3; 348/231.5; 348/239

(57) ABSTRACT

An image capture device such as a camera has associated with it a storage device in which is stored pre-programmed information relating to one or more locations, areas or places. The camera may also include one or more position sensors to determine the position of the camera, which information is employed by a processor to select portions of the stored information most pertinent to the user's current position.

### FIELD OF THE INVENTION

This invention relates to an image capturing device and, in particular but not exclusively, to a portable camera.

### BACKGROUND TO THE INVENTION

There are three main problems often faced, or at least issues to be addressed, by tourists and visitors to an unfamiliar area or attraction. The first of these is the problem that actually finding places of interest or sights to visit in the area can often be difficult. Of course, printed maps and guidebooks can help to find places that might be of interest to them, but among other disadvantages, such aids cannot adapt themselves to the time of day, the season or the specific current location of a tourist.

A second issue often addressed is the taking of good photographs to accurately and properly preserve the memory of such visits. Of course, conventional cameras permit pictures of current views to be captured, but they provide no indication as to whether the user is capturing one of the best views or whether there might be better views available nearby.

Finally, a third problem which often arises is that of remembering the location and time at which photographs were taken and/or any stories, historical information etc. related thereto, when the user returns from the visit. Some cameras do, of course, record date and possibly time information relating to when a photograph was actually taken or an image was captured. However, conventional cameras and other image capturing devices do not typically provide any facility for recording location information, nor do they have any facility for storing any historical or reference information regarding the area in which an image was captured.

U.S. Pat. No. 6,023,241 relates generally to a device for recording information about locations that may be visited in the course of travel. It describes a player and recorder including a still or motion picture camera and a global positioning system (GPS). A display screen is provided for displaying information recorded by the camera as well as GPS information such as current time and location or mapping information. The device may alos include a wireless IR or RF link to communicate with other devices. The device may receive and display information about different excursions one might take from a remote excursion server. For example, the remote excursion server may provide a guided tour including images, global positioning system coordinates, maps and audio information to facilitate a trip. The recorder can also store multimedia, such as video, audio and data files, in association with one another so that a multimedia presentation may be provided as a permanent record of a user's visit to a particular location or place. For example, a digital image of a particular landmark may be stored in association with an audio description of that landmark and GPS coordinates which locate the landmark. This multimedia (apart from the GPS coordinates) is entirely user-defined and entered, and there is no interaction between the recorder and the tourist guide functions. Furthermore, the requirement to receive the tourist guide information from a remote server, and the requirement for a GPS arrangement to enable location determination, means that the described device can never operate as a stand-alone device. As such, the described functionality of the device makes it relatively expensive to manufacture and possibly impractical for many applications.

We have now devised an improved arrangement which overcomes the problems identified above.

### SUMMARY OF THE INVENTION

Thus, in accordance with the present invention, there is provided a storage device for connection to, or incorporation in, an image capturing device, said storage device having stored therein pre-programmed information relating to one or more locations, areas or places, said information being stored in such a way as to enable a user to selectively add to, or otherwise modify, said information and store said modified information in said storage device.

Thus, tourist guide information pre-programmed into the storage device can be used as a guide to facilitate a trip, but can also be modified (for example, a previously stored image of a landmark or the like may be replaced by an image of the same landmark captured by the user during a visit to that landmark), and the modified information can be stored to provide a permanent record of the user's trip. Because the information is pre-programmed into the device, there is no requirement for communication by the device with any other, remote devices. As such, the device can operate as a stand-alone device and can accordingly be made relatively inexpensive, as may be required for certain applications.

In accordance with another aspect of the present invention, there is provided a camera including a storage device connected thereto, or incorporated therein, the storage device being pre-programmed with a plurality of images relating to one or more locations, areas or places, the camera further including an image processor for comparing an image captured by the camera with said plurality pre-programmed images to identify a match.

In accordance with yet another aspect of the present invention, there is provided a camera including a memory device connected thereto, or incorporated therein, the memory being preprogrammed with one or more data items relating to one or more locations, areas or places, the camera further including a processor for replacing a pre-programmed data item in the memory device with a data item captured or input by a user so as to create a personalised record of the user's visit to a location, area or place.

The personalised record can then, for example, be printed so as to produce a hard copy of the record as a physical souvenir.

In accordance with yet another aspect of the present invention, there is provided a camera including pre-recorded images of a location, area or place, and comprising an image processor for receiving an image of a location, area or place captured by the camera, blending the captured image with a corresponding pre-recorded image to create an enhanced version of the captured image, and storing the enhanced version of the captured image in place of the corresponding pre-recorded image.

According to another aspect of the present invention, there is provided a disposable camera having a memory connected thereto, or incorporated therein, the memory being preprogrammed with information relating to one or more locations, areas or places, said information being stored in such a way as to enable a user to selectively add to, or otherwise modify, said information and store said modified information in said memory.

The storage device may have stored therein one or more maps, and/or one or more route finders/planners, and/or tourist information relating to one or more locations, areas or places. Such tourist information may comprise a tourist guide including printed information and photographs relating to one or more locations, areas or places. In addition, or alternatively, said pre-programmed information may comprise an audio (tourist) information guide.

The pre-programmed information is beneficially (but not necessarily) externally viewable on a display screen or the like, and the storage device may include means for enabling user-defined information to be entered and stored therein. In any event, the device beneficially comprises means for enabling a user to access selected portions of said stored information.

The present invention also extends to an image capturing device having connected thereto, or incorporated therein, a storage device as defined above, the image capturing device preferably including a display screen (such as an LCD) for displaying said stored information. However, in its simplest form, the image capturing device may comprise a conventional image capturing device (without display means) but including position sensing means and alarm means (preferably audible and/or visual) for alerting a user that something of interest is nearby.

The image capturing means may include means for recording noise (ambient or otherwise) when it captures an image, and means for storing said captured image together with said recorded noise in said storage device.

The image capturing device preferably includes means for storing in said storage device one or more images captured by said image capturing device, and may also include means for adding user-defined information and/or information stored in said storage device to an image captured by said image capturing means.

The image capturing device beneficially includes object matching means for matching one or more features appearing in an image captured by said image capturing device with one or more features appearing in images stored in said storage device to determine the location, place or area at which said image has been captured. The device may, in addition or alternatively, include local position determining means, such as global position sensing (GPS) means or the like, for determining the location, area or place in which said image capturing device is located at any given time. The device may also include a compass or attitude server to determine the orientation of the image capturing device.

Means may be provided for selecting appropriate portions of information stored in said storage device according to the determined location of said image capturing device.

The image capturing device may beneficially include time and/or date determining and/or recording means for determining the time of year and/or day at which a user is visiting a particular location, area or place for selecting appropriate portions of the information stored in said storage device accordingly, and/or for recording the time and/or date on which an image is captured by the image capturing device. In one embodiment of the invention, the preprogrammed data may include seasonal information such as a paragraph of textual data relating to, for example, the Lake District in winter which can be automatically or selectively viewed on the display screen, modified or added to the user's photograph if the time/date determining means determines that the data is seasonally appropriate.

The device may include means for performing image processing algorithms so that there is less ambiguity in the data captured by the device, and the captured image quality is maximised. For example, the device may be arranged to take into account the time of day and/or year at which an image is captured. In addition, or alternatively, the device may be arranged to determine the camera angle at which an image is captured and to blend the captured image with a very high quality image of the same place (previously captured and stored in the device) so as to maximise image quality.

In a preferred embodiment of the invention, the image capturing device may include means for providing a wireless link to information available via the Internet or other communication medium. Said wireless link could be used to transmit images captured by an image capturing device for storage at a particular URL, to provide the possibility for a self-calibrating world touring guide (giving access to other people's captured images of places of interest).

Further objects and features of the present invention will become apparent from the following detailed description of an exemplary embodiment of the present invention.

### BRIEF DESCRIPTION OF THE DRAWINGS

An embodiment of the present invention will now be described by way of example only with reference to the accompanying drawings, in which:

FIG. 1 is a schematic block diagram of an image capturing device according to an exemplary embodiment of the present invention;

FIG. 2A shows a stored image of a landmark and FIG. 2B shows a user image of a landmark, the two images being suitable for blended combination in accordance with embodiments of the invention;

FIGS. 3A and 3B illustrate a blending mask used in one embodiment of the invention;

FIG. 4 shows a blended image using the images of FIGS. 2A and 2B and the blending mask of FIGS. 3A and 3B;

FIGS. 5A and 5B illustrate a blending mask used in a further embodiment of the invention; and

FIG. 6 shows a blended image using the images of FIGS. 2A and 2B and the blending mask of FIGS. 5A and 3B.

### DETAILED DESCRIPTION OF THE INVENTION

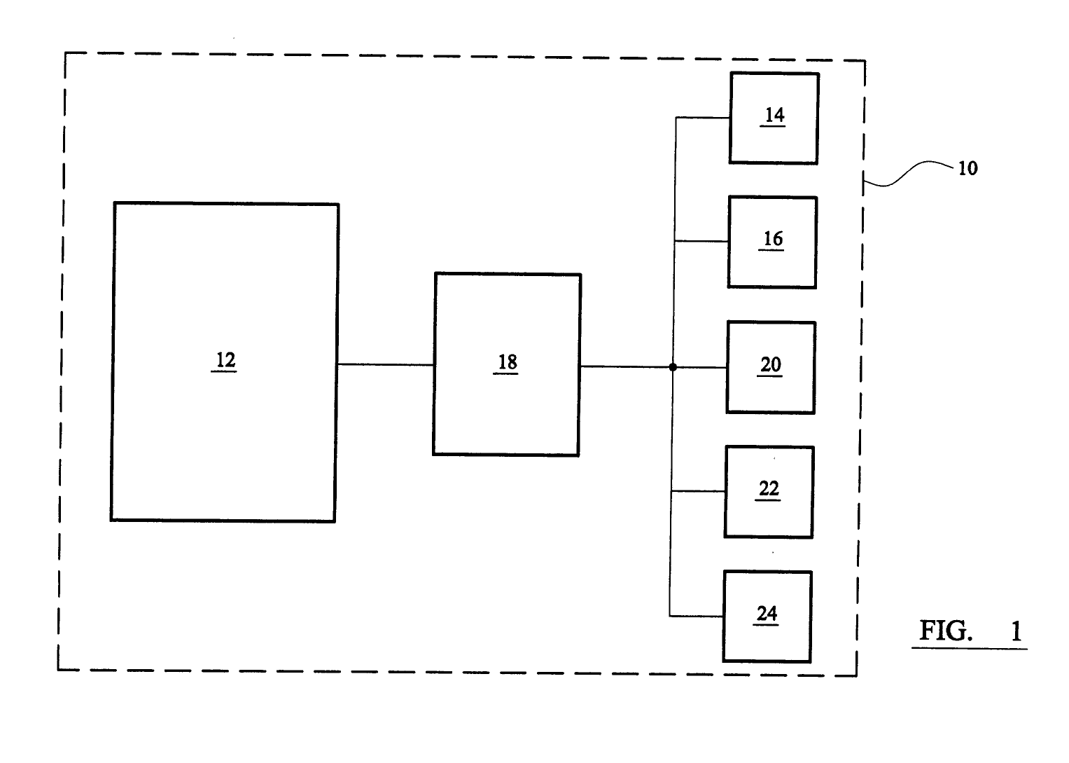

Referring to FIG. 1 of the drawings, an exemplary embodiment of the present invention comprises a digital camera 10 including a display 12, control circuitry 14, an image sensor 16, a processor 18, storage means 20, time/date determining and means 22, and one or more position sensors 24.

The display 12 functions as the camera viewfinder for determining and adjusting the field of view of the camera 10, and as a screen for reviewing photographs taken by the user (as in a conventional digital camera). The storage means 20 may store maps, tourist information and the like relating to one or more locations. In fact, the storage means 20 may store electronically a complete tourist guide (including sample photographs, information, etc.) relating to one or more locations.

In more detail, a tourist guide relating to a location or place of interest may comprise a series of still images, each depicting a significant subject which can be found at that location or place of interest. For example, if the tourist guide relates to London, it may comprise a series of still images, each depicting a respective significant London landmark, such as Buckingham Palace, Big Ben, Westminster Abbey, Saint Paul's Cathedral, The Houses of Parliament, etc. Some or all of the images may have textual or audio data corresponding thereto, which data comprises information relating to the respective subject(s) of the images. The tourist guide may additionally include other data or information relating to the landmarks, such as details of entry fees, opening times, seasonal information, suitability for disabled persons/children, etc. And/or relating to the location generally, such as a map of the area indicating where the image subjects can be found. Alternatively, or in addition, the tourist guide may comprise video data depicting the location of interest, together with audio and/or textual information relating thereto. The nature and format of the tourist guide would be conveniently dependent on the nature of the camera, in the sense that if the camera is a still camera, it may be more appropriate to provide a tourist guide consisting of still images and associated information, whereas a tourist guide stored in a video camera may more appropriately consist of video images and associated data. The remainder of this detailed description refers to a still camera having stored therein a tourist guide consisting of a series of sample photographs together with (optionally) textual and/or audio information relating to the subject(s) of the photographs.

The tourist guide is viewable via the display screen 12, and browsable by the user (as with any tourist guide) so that places of interest can be determined and a suitable route planned. Any visual information accompanying the displayed images may also be displayed on the display screen 12, but any audio data will obviously require the provision of speaker means to allow the audio information heard by a user. The storage means 20 may be included in the processor 18. Alternatively, the processor 18 may include an additional storage means (not shown). Either storage means may be removable.

During a journey or tour, the sample photographs stored as part of the tourist guide can be replaced by photographs taken by the user as desired, thereby providing a personalised record for future reference. Thus, such a pre-programmed information guide serves the dual purpose of aiding the user in planning their journey or tour, and means for providing a complete electronically stored record of the journey or tour for future reference. Said pre-programmed information may comprise a documentary consisting of a plurality of images together with audio data in the form of a voice-over or the like comprising information relating to said images. The arrangement may comprise means for replacing one or more of the stored images with images of the same places captured by the user using the device.

Alternatively, or in addition, the descriptions used in the tourist guide to annotate the sample photographs of a particular place of interest can be added to the user's photograph(s) of the same place so as to provide a set of annotated photographs which can be mounted in an album or the like to provide a hard-copy record of the journey or tour. In another embodiment of the invention, means may be provided for the user to define and add their own annotations to their photographs, if desired. Such annotations could be text or voice annotations, using appropriate known technologies.

The position sensors 24, which may comprise a global positioning system (GPS) or similar local position determining means, operate to determine the location of the camera, and this information is employed by the processor 18 to determine which section of the tourist guide is most pertinent to the user, thereby aiding the user in planning their route and highlighting other places of interest or photograph opportunities which may be nearby. Using this information, the processor can also update a map (stored as part of the pre-programmed tourist guide) recording the route followed by the user to provide a record of the route taken and places visited during a trip.

The processor 18 may compare a captured image with the images stored in the storage means 20 to aid in replacing the corresponding sample photograph stored as part of the tourist guide. In one embodiment of the invention, the image sensor 16 operates to recognise or match one or more features in a scene with a known locality and, in conjunction with the position sensors 24, determines therefrom the location of the camera 10 (which may obviate the need for a compass or attitude sensor in some embodiments of the invention). Known image matching technologies can be used for this purpose. Exemplary techniques are discussed in Lisa Gottesfeld Brown, “A survey of image registration techniques”, ACM Computing Surveys, 24(4):325-376, December 1992. Specific application to place recognition is discussed in Ulrich, I., and Nourbakhsh, I. 2000, “Appearance-Based Place Recognition for Topological Localization” in Proceedings of the IEEE International Conference on Robotics and Automation, in press.

In more detail, many different methods of image recognition are known in the art, although the matching problem can, in this case, be expressed more simply than many because of the known presence in the image of a specific characteristic element (which makes the image an interesting one to capture, such as Nelson's Column or the Taj Mahal). Since even one still image comprises a relatively large amount of data, the image data forming each of the images of the tourist guide is beneficially compressed prior to storage thereof, so as to minimise the memory capacity required to store the images. Restoration or decompression of the compressed image data allows an original image to be readily reproduced and displayed on the display screen 12, as required by the user.

Methods for producing compressed image data from a still image include the Joint Photographic Experts Group (JPEG) compression technique, in which discrete cosine transform (DCT), an orthogonal transform technique, and Huffmann coding are used to compress still image data. For moving images, band compression by the Moving Pictures Expert Group (MPEG) technique is known, whereby image data uncluding audio information can be compressed.

In order to search images compressed by such techniques to identify a match between an image captured by the camera and an image of the same subject stored as part of the tourist guide, known pattern matching techniques may be employed between the captured image and the stored image (which is decompressed for this purpose) until a match is determined. However, using this method, because each of the stored images must be restored prior to pattern matching, a high computational load would be placed on the processor 18, which would adversely affect the speed at which the searching function can be performed (particularly in the case where the tourist guide consists of a large number of captured images).

It is therefore preferred to employ an image recognition method which can be performed in respect of the compressed image data. One known image recognition method involves computing and storing DC components indicating average intensity or brightness of each of a plurality of blocks making up each of the stored images. The captured image is processed to obtain average intensity values for each of the corresponding blocks making up that image, and these average intensity values are compared against the values computed for each stored image until a closest match is found. Only then is the matched image decompressed and conventional fine pattern techniques used to confirm the match.

To determine orientation of the user's image, the stored image for matching may in fact be a plurality of images taken from different orientations to allow matching against an effective stored image taken from an equivalent location (derived by interpolation or any other appropriate technique). Using such an approach, parts or all of the user's image can be improved or replaced by blending with an existing (i.e. stored) high quality image or set of images using known blending techniques. Exemplary blending techniques are discussed in Porter, T. and Duff, T. “Compositing digital images” in Christiansen, H., editor, Computer Graphics (SIGGRAPH '84 Proceedings), volume 18, pages 253-259, July 1984, with sophisticated approaches discussed in J. Ogden, E. Adelson, J. Bergen, and P. Burt, “Pyramid Based Computer Graphics”. RCA Engineer, volume 30, pages 4-15, 1985 and in P. J. Burt, E. H. Adelson, “The Laplacian Pyramid as a Compact Image Code,” IEEE Trans. on Communications, pp. 532-540, April 1983.

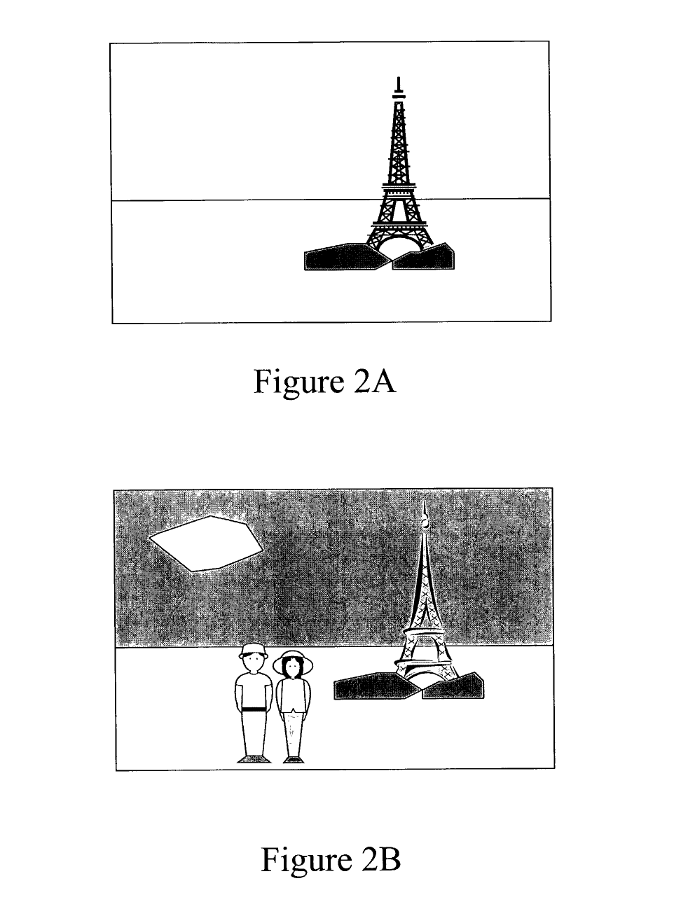

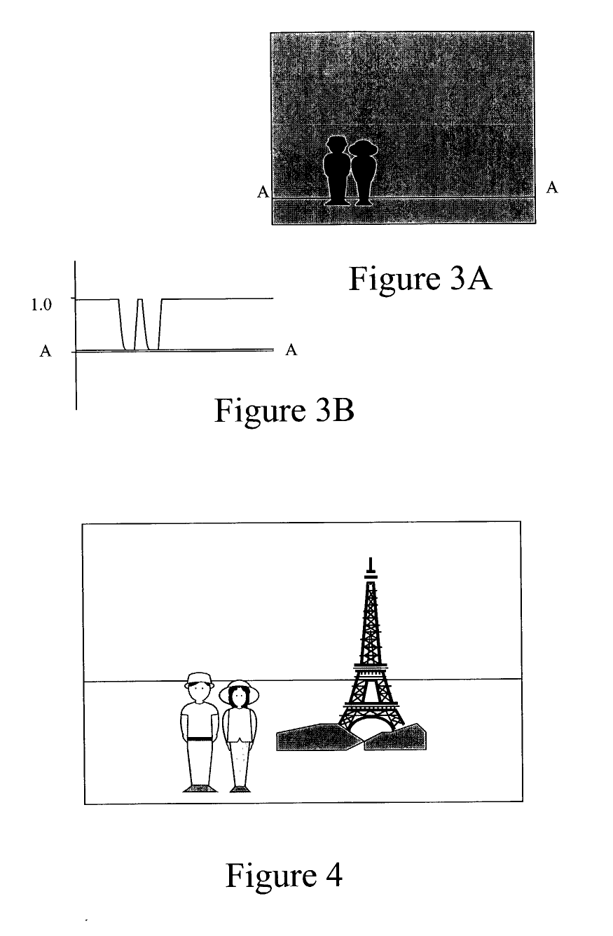

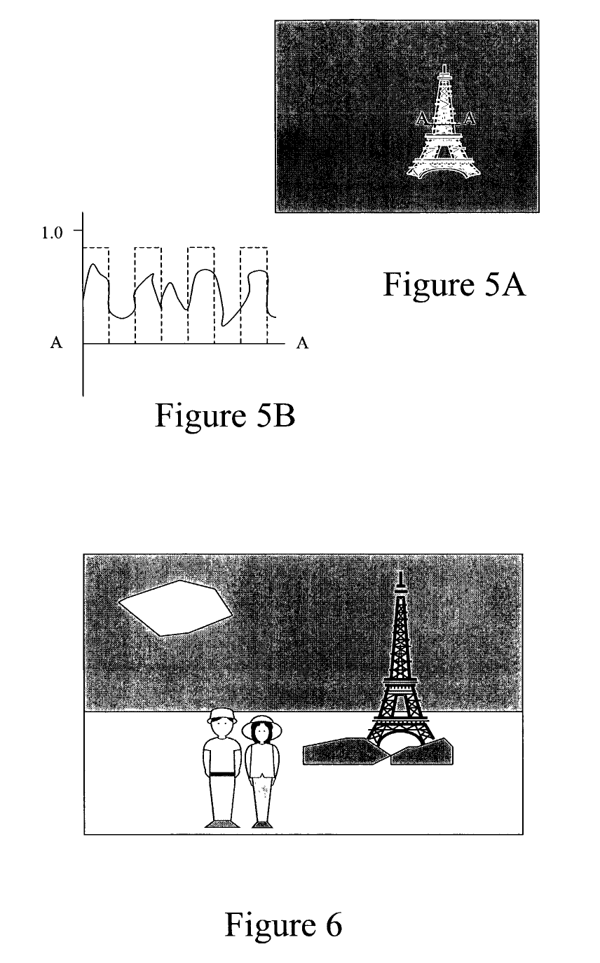

A stored view of a landmark is shown in FIG. 2A, with a user image of the landmark (with added people) shown in FIG. 2B. For convenience, these images are shown as simple graphical images rather than as photographic images. It should be noted that the FIG. 2A image is of generally higher quality—it represents an image captured in closer to optimal conditions. Two exemplary approaches to improving the user image by blending will now be discussed. The first approach, discussed with reference to FIGS. 3 and 4, involves blending objects from the user image into the stored image, whereas the second approach, discussed with reference to FIGS. 5 and 6, involves enhancement of the user image by using the stored image.

In the first approach, it is first necessary to locate which objects in the user image are required. This can be done, after establishing registration between the user image and the stored image (as discussed above) by differencing between the user image and the stored image in such a manner as to suppress minor features (such as noise, and in this case, clouds)—areas of significant contrast and difference from the stored image can thus be selected. The result is, as shown in FIG. 3A, a mask. FIG. 3B shows mask values for a horizontal slice A-A through the photograph passing through the two foreground figures in the user image—the mask has a value of 1.0 where the stored image is to be used, and a value of 0.0 where the user image is to be used. Intermediate values, at the boundary between 0.0 and 1.0 regions, indicate interpolation (either standard liner interpolation or a more sophisticated combination) between user image and stored image.

The resulting image is shown in FIG. 4. The picture is essentially that in the stored image, with the inclusion of the foreground figures from the user image. The unwanted features of the user image—from noise through to clouds—are not present in the blended composite image.

In the second approach, it is again necessary to achieve registration between the user image and the stored image. Once this is achieved, there is some possibility of using the stored image generally to identify noise in the user image and to remove it—this is however dependent on numerous variables (differences in lighting, image capture pipeline) and is not a straightforward task to apply across the image as a whole. Clear practical benefit can however be obtained from selecting regions in the stored image and using these to enhance similar regions in the user image. These may be pre-determined—for example, in the FIG. 2A stored image the Eiffel Tower may be selected for enhancement. It will be necessary to determine where this region is occluded by other objects, but when this is done enhancement to the selected region can be achieved.

This process is illustrated in FIGS. 5A and 5B. FIG. 5A shows a mask computed around the Eiffel Tower. The dotted line in FIG. 5B shows the pixel luminance along the line A-A in the stored image, and the solid line shows the pixel luminance along the comparable line in the user image. The stored image shows greater contrast, and lacks noise (and some mis-registration) present in the user image. Using the relevant part of the stored image, contrast can thus be improved and noise removed from this key part of the user image.

The result is shown in FIG. 6. Arguably, this result is more natural than that of FIG. 4—the image is the user image with a key area—the Eiffel Tower landmark—enhanced by blending in the relevant part of the higher quality stored image. Other features of the user image—such as the clouds—are retained.

The camera 10, may comprises a disposable digital or analogue camera pre-programmed with a tourist guide relating to one particular area, such as the Lake District. Once the user has completed, recorded and developed the photographs relating to the journey, the camera 10 can be discarded. In any event, the storage means 20 may be integrated into the camera 10 and pre-programmed with the necessary information. In an alternative embodiment, the camera 10 may comprise a standard digital or analogue camera, the invention being realised by means of a pre-programmed module which can be plugged into, or otherwise connected to, the camera 10 to provide the tourist guide information, etc. relating to one of a plurality of places of interest. Thus, once the user has completed their journey, the module can be removed from the camera and discarded, and replaced as necessary with a module relating to another place of interest.

The time/date determining and recording means 22 allows details provided to the user of a particular place of interest to be adapted according to the season and time of day, and/or it may simply emphasise particular aspects or recommend activities and/or photograph opportunities accordingly. The time/date determining and recording means 22 also permits the appropriate dates and times to be recorded on route recording maps and photographs as required.

The camera 10 may also include means for providing a wireless link to information not stored therein, such as websites or web resources provided by the Internet, to view, for example, other people's photographs of a particular sight, historical photographs of the same scene, etc.

It will be appreciated that the application of the present invention is not necessarily limited to use in connection with traditional tourism, but may also have application in, for example, specialist tours of museums, buildings, building sites and the like.

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. A storage device for connection to, or incorporation in, an image capture device, the storage device having stored therein pre-programmed information relating to one or more locations, areas or places, said information being stored in such a way as to enable a user to selectively add to, or otherwise modify, said information and store said modified information in said storage device.

2. A camera having connected thereto, or incorporated therein, a storage device according to claim 1.

3. A camera including a storage device connected thereto, or incorporated therein, the storage device being pre-programmed with a plurality of images relating to one or more locations, areas or places, the camera further including an image processor for comparing an image captured by the camera with said plurality pre-programmed images to identify a match.

4. A camera according to claim 3, wherein the image processor is arranged to compare an image captured by the camera with the pre-programmed images to identify a match and thereby determine the location of the camera.

5. A camera including a memory device connected thereto, or incorporated therein, the memory being pre-programmed with one or more data items relating to one or more locations, areas or places, the camera further including a processor for replacing a pre-programmed data item in the memory device with a data item captured or input by a user so as to create a personalised record of the user's visit to a location, area or place.

6. A camera according to claim 5, wherein said data items include one or more images, maps, or route planners or finders, or tourist information relating to said one or more locations, areas or places.

7. A camera according to claim 6, wherein said tourist information comprises a tourist guide including printed information and photographs relating to one or more locations, areas or places.

8. A camera according to claim 5, wherein said pre-programmed data items include an audio information guide.

9. A camera according to claim 5, including a display device for displaying said one or more data items.

10. A camera according to claim 5, comprising apparatus for enabling a user to access selected ones or portions of said one or more data items.

11. A camera according to claim 5, including noise recording apparatus for recording noise (ambient or otherwise) when it captures an image, and for storing said captured image together with said recorded noise in said memory device.

12. A camera according to claim 6, including object matching apparatus for matching one or more features appearing in an image captured by said camera with one or more features appearing in images stored in said memory device to determine the location, place or area at which said image has been captured.

13. A camera according to claim 5, including local position determining means, such as global position sensing (GPS) means or the like, for determining the location, area or place in which said camera is located at any given time.

14. A camera according to claim 5, including a compass or attitude sensor for determining the orientation of the camera.

15. A camera according to claim 5, including time and/or date determining and/or recording apparatus for determining the time of year and/or day at which a user is visiting a particular location, area or place for selecting appropriate portions of the information stored in said storage device accordingly, and/or for recording the time and/or date on which an image is captured by the camera.

16. A camera according to claim 15, wherein said pre-programmed data items include seasonal data relating to said one or more locations, areas or places, which data items can be automatically or selectively viewed, modified or added to a user's photograph if said time/date recording apparatus determines that said data is seasonally appropriate.

17. A camera according to claim 5, wherein said personalised record can be printed so as to produce a hard copy version of said personalised record.

18. A camera according to claim 5, including a wireless communication link to obtain information from a remote device or location via a remote communication medium.

19. A camera including pre-recorded images of a location, area or place, and comprising an image processor for receiving an image of a location, area or place captured by the camera, blending the captured image with a corresponding pre-recorded image to create an enhanced version of the captured image, and storing the enhanced version of the captured image in place of the corresponding pre-recorded image.

20. A disposable camera having a memory connected thereto, or incorporated therein, the memory being pre-programmed with information relating to one or more locations, areas or places, said information being stored in such a way as to enable a user to selectively add to, or otherwise modify, said information and store said modified information in said memory.
